(19) United States
(12) Patent Application Publication
(10) Pub. No.: US 2018/0101046 A1
(43) Pub. Date: Apr. 12, 2018

(54) LIQUID CRYSTAL PANEL, DISPLAY AND TERMINAL

(71) Applicant: Shenzhen China Star Optoelectronics Technology, Shenzhen, Guangdong (CN)

(72) Inventors: Jie CHEN, Shenzhen, Guangdong (CN); Dike SHAN, Shenzhen, Guangdong (CN); Shih-ying SUN, Shenzhen, Guangdong (CN)

(73) Assignee: Shenzhen China Star Optoelectronics Technology Co., Ltd., Shenzhen, Guangdong (CN)

(21) Appl. No.: 15/106,770

(22) PCT Filed: Apr. 29, 2016
(86) PCT No.: PCT/CN2016/080811

§ 371 Date: Jun. 20, 2016

(30) Foreign Application Priority Data
Mar. 2, 2016 (CN) 201610117745.5

(51) Int. Cl. G02F 1/1333; G02F 1/1339; G02F 1/1345

(52) U.S. Cl. CPC G02F 1/133308; G02F 1/1345; G02F 1/133305; G02F 1/1339

(57) ABSTRACT

Disclosed is a liquid crystal panel, comprising a first substrate, a second substrate and liquid crystal located between the first substrate and the second substrate, wherein the liquid crystal panel further comprises a first seal part to seal a gap between the first substrate and the second substrate, and the first seal is located along an edge of the first substrate, and the edge of the first substrate corresponding to the first seal part contracts inwardly relative to an edge of the second substrate close to the first seal part to expose a portion of the second substrate to form a protruding part, and the protruding part is employed to carry the first seal part. The liquid crystal panel can prevent the seal part break and the large coating location deviation, and thus to avoid the issue of the poor seal between the first substrate and the second substrate.

### CROSS REFERENCE

This application claims the priority of Chinese Patent Application No. 201610117745.5, entitled “Liquid crystal panel, display and terminal”, filed on Mar. 2, 2016, the disclosure of which is incorporated herein by reference in its entirety.

### FIELD OF THE INVENTION

The present invention relates to a liquid crystal display field, and more particularly to a liquid crystal panel, a display and a terminal.

### BACKGROUND OF THE INVENTION

The display is usually to show the text or the image. With the constant development of the display technology, the displays have applications in many fields, and more particularly for the liquid crystal panel. In the respective specific applications, the various specific performance properties of the liquid crystal panels are necessary. Thus, the various specific applications in kinds of fields require the liquid crystal panels of different sizes. In case that the liquid crystal panel has to be designed independently for every size, the design cost and the production cost will be higher. From an economic point of view, the maker provides the universal design solution as producing the liquid crystal panels so that all the liquid crystal panels have the properties which are basically the same and the unified size specification. Then, while producing the liquid crystal panels of other specification in a small amount, these sizes can be changed without additional design for decreasing the design cost. Besides, as the non circuit integration end of the liquid crystal panel appears the poor display in the mass production, the end can be removed; in the check and test stage of the liquid crystal panel, it is also required to cut the liquid crystal panel for adjusting the size for adapting with the size of the test equipment.

In prior art, the liquid crystal panel of certain size is generally manufactured in advance, and then it is cut to be the liquid crystal panel of the required size. The adhesive or other material which is fluid and curable is coated to form a seal part.

The liquid crystal panel generally comprises a first substrate and a second substrate. In the process of cutting the liquid crystal panel according to prior art, after finishing cutting, the sections of the first substrate and the second substrate are aligned at the cutting position. Therefore, the adhesive can only be coated on the aligned sections of the first substrate and the second substrate. The phenomenon of the seal part break and the large coating location deviation can easily happen as coating due to the contact area of the adhesive and the sections is too small or the sections are uneven. Accordingly, it leads to the poor seal between the first substrate and the second substrate.

### SUMMARY OF THE INVENTION

An objective of the present invention is to provide a liquid crystal panel, which can prevent the phenomenon of the seal part break and the large coating location deviation, and thus to avoid the issue of the poor seal between the first substrate and the second substrate.

For solving the aforesaid technical issue, the technical solution employed by the present invention is:

First, the present invention provides a liquid crystal panel, and the liquid crystal panel comprises a first substrate, a second substrate and liquid crystal located between the first substrate and the second substrate, wherein the liquid crystal panel further comprises a first seal part which is employed to seal a gap between the first substrate and the second substrate, and the first seal is located along an edge of the first substrate, and the edge of the first substrate corresponding to the first seal part contracts inwardly relative to an edge of the second substrate close to the first seal part to expose a portion of the second substrate to form a protruding part, and the protruding part is employed to carry the first seal part.

The first seal part comprises a first border and a second border which are opposite, and the first border is away from the protruding part, and the first border is sandwiched between the first substrate and the second substrate, and the second border is located on the protruding part.

A distance that the edge of the first substrate close to the first seal part contracts inwardly relative to the edge of the second substrate close to the first seal part is in a range of 1 millimeter to 10 millimeter.

The liquid crystal panel further comprises a second seal part, and the second seal part is located on the second substrate and extends along the edge of the first substrate, and the second seal part and the first seal part are connected end to end, and the second seal part is completely sandwiched between the first substrate and the second substrate.

A distance of the first border of the first seal part from the edge of the first substrate close to the first seal is at least 0.1 millimeter.

The liquid crystal panel further comprises a flexible circuit board, and the flexible circuit board is located at one end of the liquid crystal panel, and the first seal part is located at one end of the liquid crystal panel away from the flexible circuit board.

The first seal part and the second seal part are light curing agent or heat curing agent.

The first substrate is a thin film transistor array substrate, and the second substrate is a color filter component; or the first substrate is a color filter component, and the second substrate is a thin film transistor array substrate.

Second, the present invention further provides a display, and the display comprises any one of the aforesaid liquid crystal panels.

Second, the present invention further provides a terminal, and the terminal comprises the aforesaid display.

Compared with prior art, the technical solution of the present invention at least possesses benefits below:

In the technical solution of the present invention, because the liquid crystal panel comprises the first seal part which is employed to seal the gap between the first substrate and the second substrate, and the first seal part is located along a portion of the first substrate, and the edge of the first substrate corresponding to the first seal part contracts inwardly relative to an edge of the second substrate close to the first seal part to expose a portion of the second substrate to form a protruding part. Therefore, in the process of forming the first seal part, the protruding part can be a carry platform for carrying the material of forming the first seal part on the protruding part, and because the protruding part belongs to a portion of the second substrate, and is at the same plane with the second substrate, and thus, the material of forming the first seal part can permeate between the first substrate and the second substrate more easily, to prevent the phenomenon of the first seal part break and the large coating location deviation, and thus to avoid the issue of the poor seal between the first substrate and the second substrate.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a laminated structure diagram of a liquid crystal panel in the first embodiment of the present invention; and

FIG. 2 is a laminated structure diagram of a liquid crystal panel in the second embodiment of the present invention.

### DETAILED DESCRIPTION OF PREFERRED EMBODIMENTS

Embodiments of the present invention are described in detail with the technical matters, structural features, achieved objects, and effects with reference to the accompanying drawings as follows. It is clear that the described embodiments are part of embodiments of the present invention, but not all embodiments. Based on the embodiments of the present invention, all other embodiments to those of ordinary skill in the premise of no creative efforts obtained, should be considered within the scope of protection of the present invention.

Besides, the following descriptions for the respective embodiments are specific embodiments capable of being implemented for illustrations of the present invention with referring to appended figures. For example, the terms of up, down, front, rear, left, right, interior, exterior, side, etcetera are merely directions of referring to appended figures. Therefore, the wordings of directions are employed for explaining and understanding the present invention but not limitations thereto.

In the description of the invention, which needs explanation is that the term “installation”, “connected”, “connection” should be broadly understood unless those are clearly defined and limited, otherwise, For example, those can be a fixed connection, a detachable connection, or an integral connection; those can be a mechanical connection, or an electrical connection; those can be a direct connection, or an indirect connection with an intermediary, which may be an internal connection of two elements. To those of ordinary skill in the art, the specific meaning of the above terminology in the present invention can be understood in the specific circumstances.

Besides, in the description of the present invention, unless with being indicated otherwise, “plurality” means two or more. In the present specification, the term “process” encompasses an independent process, as well as a process that cannot be clearly distinguished from another process but yet achieves the expected effect of the process of interest. Moreover, in the present specification, any numerical range expressed herein using “to” refers to a range including the numerical values before and after “to” as the minimum and maximum values, respectively. In figures, the same reference numbers will be used to refer to the same or like parts.

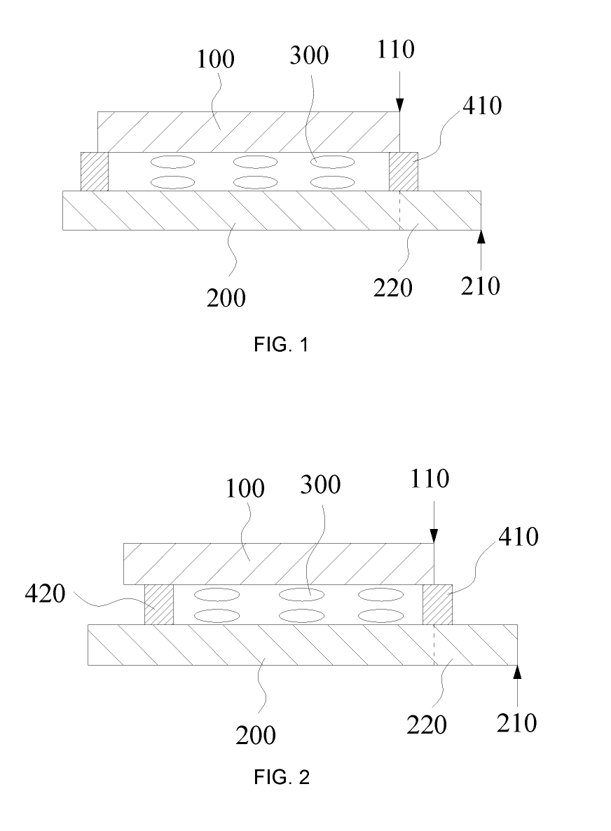

Please refer to FIG. 1. FIG. 1 is a laminated structure diagram of a liquid crystal panel in the first embodiment of the present invention. In the first embodiment of the present invention, the liquid crystal panel comprises a first substrate 100, a second substrate 200 and liquid crystal 300 between the first substrate 100 and the second substrate 200. The liquid crystal panel further comprises a first seal part 410 which is employed to seal a gap between the first substrate 100 and the second substrate 200, and the first seal part 410 can prevent the leakage of the liquid crystal 300. The first seal part 410 is located along an edge of the first substrate 100. In one embodiment, the first seal part 410 can be located on all edges (i.e. the periphery edges) of the first substrate 100, and certainly, in other embodiment, the first seal part 410 can be located on a portion of edges of the first substrate 100. The second substrate 200 comprises a protruding part 220. The edge 110 of the first substrate 100 corresponding to the first seal part 410 contracts inwardly relative to an edge 210 of the second substrate 200 close to the first seal part 410 to form a protruding part 220. The protruding part 220 is employed to carry the first seal part 410. In the formation process of the first seal part 410, the protruding part 220 is employed for carrying the material of forming the first seal part 410, and thus, the material of forming the first seal part 410 can permeate between the first substrate 100 and the second substrate 200 more easily. The dot lines in figure shows the borders of the protruding part 220 and the rest portion of the second substrate 200.

Preferably, a distance that the edge of the first substrate 100 close to the first seal part 410 contracts inwardly relative to the edge of the second substrate 200 close to the first seal part 410 can be in a range of 1 millimeter to 10 millimeter. Namely, the protruding distance that the protruding part 200 protrudes outwardly relative to the first substrate 100 can be in a range of 1 millimeter to 10 millimeter.

The material of forming the first seal part 410 can be adhesive or other material which is fluid and curable. The adhesive is preferably to be fluid, which can be light curing agent or heat curing agent.

The first substrate 100 can be a thin film transistor array substrate, and then, the second substrate 200 can be a color filter component; it should be understood that the first substrate 100 also can be a color filter component, and then, the second substrate 200 can be a thin film transistor array substrate.

In one embodiment, the liquid crystal panel further comprises a flexible circuit board (not shown), and the flexible circuit board is located at one end of the liquid crystal panel, and preferably, the first seal part 410 is located at one end of the liquid crystal panel away from the flexible circuit board.

Specifically, the first seal part 410 comprises a first border (not shown in figure) and a second border (not shown in figure) which are opposite, and the first border is away from the protruding part 220, and the first border is sandwiched between the first substrate 100 and the second substrate 200, and the second border is located on the protruding part 220. Thus, a portion of the first seal part 410 is located between the first substrate 100 and the second substrate 200 and extends along the edge of the first substrate 100, and the other portion of the first seal part 410 is located on the protruding part 200, and also extends along the edge of the first substrate 100 and is not covered by the first substrate 100.Preferably, a distance of the first border of the first seal part 410 from the edge of the first substrate 100 close to the first seal 410 is at least 0.1 millimeter. i.e.: a distance of the edge of the first seal part 410 sandwiched between the first substrate 100 and the second substrate 200 from the edge of the first substrate 100 close to the first seal part 410 is at least 0.1 millimeter. Thus, it can raise the seal property of the first seal part 410.

In this embodiment (the first embodiment), because the liquid crystal panel comprises the first seal part which is employed to seal the gap between the first substrate and the second substrate, and the first seal part is located long a portion of the first substrate, and the second substrate comprises a protruding part, and the edge of the first substrate corresponding to the first seal part contracts inwardly relative to an edge of the second substrate close to the first seal part to form a protruding part. Therefore, in the process of forming the first seal part, the protruding part can be a carry platform for carrying the material (such as the adhesive) of forming the first seal part on the protruding part, and because the protruding part belongs to a portion of the second substrate, and is at the same plane with the second substrate, and thus, the material of forming the first seal part can permeate between the first substrate and the second substrate more easily, to prevent the phenomenon of the first seal part break and the large coating location deviation, and thus to avoid the issue of the poor seal between the first substrate and the second substrate.

Please refer to FIG. 2. FIG. 2 is a laminated structure diagram of a liquid crystal panel in the second embodiment of the present invention. The structure of the liquid crystal in the second embodiment is basically the same as the structure in the first embodiment. The difference is: the liquid crystal panel further comprises a second seal part 420, and the second seal part 420 is located on the second substrate 200 and extends along the edge of the first substrate 100, and the second seal part 420 and the first seal part 410 are connected end to end, and the second seal part 420 is completely sandwiched between the first substrate 100 and the second substrate 200.

Specifically, the liquid crystal panel is a rectangular or an almost rectangular structure. Namely, the liquid crystal panel has four sides or edges, and the liquid crystal panel further comprises a flexible circuit board (not shown), and the flexible circuit board is located at one end of the liquid crystal panel, and the first seal part 410 is located at one end of the liquid crystal panel away from the flexible circuit board. Then, the first seal part 410 is opposite to the flexible circuit board. In one embodiment, the first seal part 410 can be located on one edge of the liquid crystal panel away from the flexible circuit board, and then the second seal part 420 can be located on the rest three edges of the liquid crystal panel. It can be understood that in other embodiment, the first seal part 410 can be located on one edge of the liquid crystal panel away from the flexible circuit board and one edge adjacent to the edge, and then the second seal part 420 can be located on the rest two edges of the liquid crystal panel; in another embodiment, the first seal part 410 can be located on one edge of the liquid crystal panel away from the flexible circuit board and two edges adjacent to the edge, i.e. the first seal part 410 can be located on three edges of the liquid crystal panel away from the flexible circuit board, and then second seal part 420 can be located on the edge of the liquid crystal panel close to the flexible circuit board.

Thus, in the cutting process of adjusting the liquid crystal panel size, it can be performed according to the requirement to cut one edge, two edges or three edges of the liquid crystal panel, of which the original size is too big, and thus to form the liquid crystal panel of the present invention with the simple method, and meanwhile, to prevent the phenomenon of the first seal part break and the large coating location deviation, and thus to avoid the issue of the poor seal between the first substrate and the second substrate.

In the embodiment of the present invention, further provided is a display, and the display comprises the liquid crystal panels in any of the aforesaid embodiments or implementations.

In the embodiment of the present invention, further provided is a terminal, such as the mobile phone, the computer or the television. The terminal comprises the aforesaid display.

In the description of the present specification, the reference terms, “one embodiment”, “some embodiments”, “an illustrative embodiment”, “an example”, “a specific example”, or “some examples” mean that such description combined with the specific features of the described embodiments or examples, structure, material, or characteristic is included in the utility model of at least one embodiment or example. In the present specification, the terms of the above schematic representation do not certainly refer to the same embodiment or example. Meanwhile, the particular features, structures, materials, or characteristics which are described may be combined in a suitable manner in any one or more embodiments or examples.

Above are embodiments of the present invention, which does not limit the scope of the present invention. Any modifications, equivalent replacements or improvements within the spirit and principles of the embodiment described above should be covered by the protected scope of the invention.

What is claimed is:

1. A liquid crystal panel, comprising a first substrate, a second substrate and liquid crystal located between the first substrate and the second substrate, wherein the liquid crystal panel further comprises a first seal part which is employed to seal a gap between the first substrate and the second substrate, and the first seal is located along an edge of the first substrate, and the edge of the first substrate corresponding to the first seal part contracts inwardly relative to an edge of the second substrate close to the first seal part to expose a portion of the second substrate to form a protruding part, and the protruding part is employed to carry the first seal part.

2. The liquid crystal panel according to claim 1, wherein the first seal part comprises a first border and a second border which are opposite, and the first border is away from the protruding part, and the first border is sandwiched between the first substrate and the second substrate, and the second border is located on the protruding part.

3. The liquid crystal panel according to claim 2, wherein a distance that the edge of the first substrate close to the first seal part contracts inwardly relative to the edge of the second substrate close to the first seal part is in a range of 1 millimeter to 10 millimeter.

4. The liquid crystal panel according to claim 3, wherein the liquid crystal panel further comprises a second seal part, and the second seal part is located on the second substrate and extends along the edge of the first substrate, and the second seal part and the first seal part are connected end to end, and the second seal part is completely sandwiched between the first substrate and the second substrate.

5. The liquid crystal panel according to claim 2, wherein a distance of the first border of the first seal part from the edge of the first substrate close to the first seal is at least 0.1 millimeter.

6. The liquid crystal panel according to claim 3, wherein a distance of the first border of the first seal part from the edge of the first substrate close to the first seal is at least 0.1 millimeter.

7. The liquid crystal panel according to claim 4, wherein a distance of the first border of the first seal part from the edge of the first substrate close to the first seal is at least 0.1 millimeter.

8. The liquid crystal panel according to claim 5, wherein the liquid crystal panel further comprises a flexible circuit board, and the flexible circuit board is located at one end of the liquid crystal panel, and the first seal part is located at one end of the liquid crystal panel away from the flexible circuit board.

9. The liquid crystal panel according to claim 5, wherein the first seal part and the second seal part are light curing agent or heat curing agent.

10. The liquid crystal panel according to claim 9, wherein the first substrate is a thin film transistor array substrate, and the second substrate is a color filter component; or the first substrate is a color filter component, and the second substrate is a thin film transistor array substrate.

11. A display, comprising a liquid crystal panel, and the liquid crystal panel comprises a first substrate, a second substrate and liquid crystal located between the first substrate and the second substrate, wherein the liquid crystal panel further comprises a first seal part which is employed to seal a gap between the first substrate and the second substrate, and the first seal is located along an edge of the first substrate, and the edge of the first substrate corresponding to the first seal part contracts inwardly relative to an edge of the second substrate close to the first seal part to expose a portion of the second substrate to form a protruding part, and the protruding part is employed to carry the first seal part.

12. The display according to claim 11, wherein the first seal part comprises a first border and a second border which are opposite, and the first border is away from the protruding part, and the first border is sandwiched between the first substrate and the second substrate, and the second border is located on the protruding part.

13. The display according to claim 12, wherein a distance that the edge of the first substrate close to the first seal part contracts inwardly relative to the edge of the second substrate close to the first seal part is in a range of 1 millimeter to 10 millimeter.

14. The display according to claim 13, wherein the liquid crystal panel further comprises a second seal part, and the second seal part is located on the second substrate and extends along the edge of the first substrate, and the second seal part and the first seal part are connected end to end, and the second seal part is completely sandwiched between the first substrate and the second substrate.

15. The display according to claim 12, wherein a distance of the first border of the first seal part from the edge of the first substrate close to the first seal is at least 0.1 millimeter.

16. The display according to claim 15, wherein the liquid crystal panel further comprises a flexible circuit board, and the flexible circuit board is located at one end of the liquid crystal panel, and the first seal part is located at one end of the liquid crystal panel away from the flexible circuit board.

17. The display according to claim 15, wherein the first seal part and the second seal part are light curing agent or heat curing agent.

18. The display according to claim 17, wherein the first substrate is a thin film transistor array substrate, and the second substrate is a color filter component; or the first substrate is a color filter component, and the second substrate is a thin film transistor array substrate.

19. A terminal, comprising a display, and the display comprises a liquid crystal panel, and the liquid crystal panel comprises a first substrate, a second substrate and liquid crystal located between the first substrate and the second substrate, wherein the liquid crystal panel further comprises a first seal part which is employed to seal a gap between the first substrate and the second substrate, and the first seal is located along an edge of the first substrate, and the edge of the first substrate corresponding to the first seal part contracts inwardly relative to an edge of the second substrate close to the first seal part to expose a portion of the second substrate to form a protruding part, and the protruding part is employed to carry the first seal part.

20. The terminal according to claim 19, wherein the first seal part comprises a first border and a second border which are opposite, and the first border is away from the protruding part, and the first border is sandwiched between the first substrate and the second substrate, and the second border is located on the protruding part.
